(19) United States
(12) Patent Application Publication
(10) Pub. No.: US 2026/0298619 A1
(43) Pub. Date: Oct. 1, 2026

(54) SYSTEM AND METHOD FOR INSPECTION AND METROLOGY OF THREE-DIMENSIONAL FEATURES

(71) Applicant: Orbotech Ltd., Yavne (IL)

(72) Inventor: Nir Turko, Rehovot (IL)

(21) Appl. No.: 19/092,620

(22) Filed: Mar. 27, 2025

(51) Int. Cl. G01B 11/06

(52) U.S. Cl. CPC G01B 11/0608

(57) ABSTRACT

The system includes a stage that holds a workpiece, a first light source that emits light, a first beam splitter that directs a first portion of the light onto the workpiece and a second portion of the light along a reference path, a refractive optical element that spatially modulates the light in the reference path, a second beam splitter that combines the light from the refractive optical element and the light reflected by the workpiece, and a first detector that generates a first detection signal based on the combined light received from the second beam splitter as the stage scans relative to the first detector. A processor is configured to generate a plurality of interference images of the workpiece based on the first detection signal, and determine a relative height of each pixel of the workpiece based on an interference contrast between corresponding pixels of the plurality of interference images.

### FIELD OF THE DISCLOSURE

This disclosure relates to semiconductor fabrication and inspection and, more particularly, to height measurement and three-dimensional imaging.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Some inspection processes rely on digital holography, in which height measurements of a sample are derived from interference between light reflected by a sample and light reflected by a reference sample. However, the height measurements are 2-pi ambiguous, meaning that heights with a different larger than half of the wavelength of the light can produce erroneous results. To address this ambiguity, some methods rely on the lateral smoothness of height changes of the sample to maintain height profile smoothness in ambiguous regions. However, these methods depend on the smoothness of the sample and still fail to address a lateral height or step change of over half a wavelength.

Some methods introduce light of two or more wavelengths, where the phase data recovered by each is slightly different. Calculating the difference between both phases produces a phase map, which corresponds to a height map of an effective larger wavelength and can be used to measure the height of a larger measurement range proportional to the inverse of the wavelengths difference. While multi-wavelength unwrapping enhances the unambiguous range of at least two phase signals, the relation of phase and height are by multiplication of the phase by the wavelength, divided by 4-pi. Thus, when multiplying the phase measurement—with the same phase noise levels—by a much larger wavelength, the noise is also multiplied. This means that if an increase of effective measurement range is required, one must pay attention to the proportionate rise in noise. Eventually, it will require highly stabilized light sources in order to make a robust measurement system for heights over 100 μm.

Other methods rely on external knowledge, such a known height of certain features of a 3D measurement by a different tool, to set a rough estimation of measured heights to unwrap ambiguous data. However, external knowledge is not always available and may not account for highly defective features. If the external knowledge is acquired by a different tool, the unwrapping process may require complex data integration and registration with a compatible measurement tool.

Therefore, what is needed is an improved method of unwrapping digital holography data for height measurements and three-dimensional imaging.

### BRIEF SUMMARY OF THE DISCLOSURE

An embodiment of the present disclosure provides a system. The system may comprise a stage configured to hold a workpiece. The system may further comprise a first light source configured to emit light. The system may further comprise a first beam splitter configured to direct a first portion of the light onto the workpiece and a second portion of the light along a reference path. The system may further comprise a refractive optical element disposed in the reference path and configured to spatially modulate the light in the reference path. The refractive optical element may have a varying refractive index profile. The system may further comprise a second beam splitter configured to combine the light from the refractive optical element and the light reflected by the workpiece. The system may further comprise a first detector configured to generate a first detection signal based on the combined light received from the second beam splitter as the stage scans relative to the first detector. The system may further comprise a processor in electronic communication with the detector. The processor may be configured to receive the first detection signal from the detector. The processor may be further configured to generate a plurality of interference images of the workpiece based on the first detection signal. The processor may be further configured to determine a relative height of each pixel of the workpiece based on an interference contrast between corresponding pixels of the plurality of interference images.

In some embodiments, the system may further comprise a second light source configured to emit light. The light emitted by the first light source may have a lower coherence than the light emitted by the second light source. The system may further comprise a second detector configured to generate a second detection signal based on the combined light received from the second beam splitter as the stage scans relative the second detector. The processor may be further configured to receive the second detection signal from the second detector. The processor may be further configured to generate the plurality of interference images based on the first detection signal and the second detection signal.

In some embodiments, the processor may be configured to determine the relative height of each pixel of the workpiece based on the interference contrast between corresponding pixels of the plurality of interference images according to the first detection signal and the second detection signal.

In some embodiments, the system may further comprise an illumination beam splitter configured to direct the light from the first light source and the second light source to the first beam splitter.

In some embodiments, the illumination beam splitter may be a polarizing beam splitter.

In some embodiments, the second detector may be configured to detect the light from the second light source and the first detector may be configured to detect light from the first light source.

In some embodiments, the system may further comprise a first reference beam splitter configured to split the light in the reference path to a secondary reference path. The system may further comprise a second reference beam splitter configured to combine the light from the reference path and the secondary reference path to be directed to the second beam splitter. The light from the reference path and the secondary reference path may be provided at different angles from the light reflected by the workpiece in the light combined by the second beam splitter.

In some embodiments, the light emitted by the second light source may have a different wavelength from the light emitted by first light source.

In some embodiments, the system may further comprise a grating disposed in the reference path between the refractive optical element and the second beam splitter. The grating may be configured to adjust the angle of the light from the refractive optical element to be off-axis from the light reflected by the workpiece in the light combined by the second beam splitter.

In some embodiments, the system may further comprise a mirror disposed in the reference path between the refractive optical element and the second beam splitter. The mirror may be configured to adjust the angle of the light received by the refractive optical element, such that the light from the refractive optical element may be off-axis from the light reflected by the workpiece in the light combined by the second beam splitter.

In some embodiments, the processor may be further configured to generate a height map of the workpiece comprising the relative height of each pixel of the workpiece in the plurality of interference images.

In some embodiments, the varying refractive index profile may be a sinusoidal profile.

In some embodiments, the refractive optical element may have a varying thickness that defines the varying refractive index profile.

In some embodiments, the refractive optical element may be a spatial light modulator.

In some embodiments, the light from the refractive optical element may be off-axis relative to the light reflected by the workpiece in the combined light received by the first detector.

In some embodiments, the plurality of interference images may comprise at least seven images captured with different spatial modulation of the light refracted by the refractive optical element.

Another embodiment of the present disclosure provides a method. The method may comprise emitting light from a first light source. The method may further comprise directing, with a first beam splitter, a first portion of the light from the first light source onto a workpiece and a second portion of the light from the first light source along a reference path. The method may further comprise spatially modulating, with a refractive optical element, the light from the first light source in the reference path. The refractive optical element may have a varying refractive index profile. The method may further comprise combining, with a second beam splitter, the light from first light source refracted by the refractive optical element and the light from the first light source reflected by the workpiece. The method may further comprise generating, with a first detector, a first detection signal based on the combined light from the first light source received from the second beam splitter as the stage scans relative to the first detector. The method may further comprise generating, with a processor, a plurality of interference images of the workpiece based on the first detection signal received from the first detector. The method may further comprise determining, with the processor, a relative height of each pixel of the workpiece based on an interference contrast between corresponding pixels of the plurality of interference images.

In some embodiments, the method may further comprise emitting light from a second light source. The light emitted by the first light source may have a lower coherence than the light emitted by the second light source. The method may further comprise directing, with the first beam splitter, a first portion of the light from the second light source onto the workpiece and a second portion of the light from the second light source along the reference path. The method may further comprise spatially modulating, with the refractive optical element, the light from the second light source in the reference path. The method may further comprise combining, with the second beam splitter, the light from second light source refracted by the refractive optical element and the light from the second light source reflected by the workpiece. The method may further comprise generating, with a second detector, a second detection signal based on the combined light from the second light source received from the second beam splitter as the stage scans relative to the second detector. The method may further comprise generating, with the processor, and a plurality of interference images based on the first detection signal and the second detection signal.

In some embodiment, determining, with the processor, the relative height of each pixel of the workpiece based on the interference contrast between corresponding pixels of the plurality of interference images may comprise determining, with the processor, the relative height of each pixel of the workpiece based on the interference contrast between corresponding pixels of the plurality of interference images according to the first detection signal and the second detection signal.

In some embodiments, the method may further comprise generating, with the processor, a height map of the workpiece comprising the relative height of each pixel of the workpiece in the plurality of interference images.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a diagram of a system according to another embodiment of the present disclosure;

FIG. 3 is a diagram of a system according to another embodiment of the present disclosure;

FIG. 4 is a flowchart of a method according to an embodiment of the present disclosure; and

FIG. 5 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

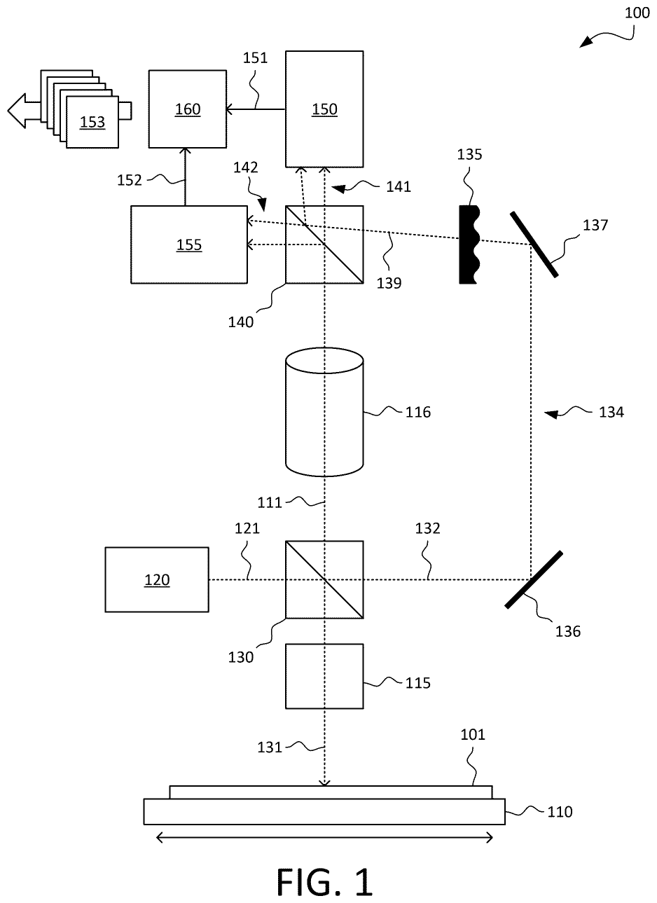

An embodiment of the present disclosure provides a system 100, as shown in FIG. 1. The system 100 may be a digital holography system configured to measure heights and/or three-dimensional features of a workpiece 101. The workpiece 101 may be a semiconductor wafer, substrate, printed circuit board (PCB), flat panel display (FPD), integrated circuit (IC), or any other type of workpiece 101 that may be inspected by the system 100. In some embodiments, the three-dimensional features of the workpiece 101 may be micro bumps. Each micro bump may have a height of 1 μm to 100 μm or more. In some embodiments, each micro bump may have a height of up to 50 μm.

The system 100 may comprise a stage 110. The stage 110 may be configured to hold the workpiece 101. The stage 110 may be movable by one or more actuators to move the workpiece 101 in one or more in-plane directions (i.e., X and Y directions) and/or a direction normal to the plane of the workpiece 101 (i.e., Z direction).

The system 100 may further comprise a first light source 120. The first light source 120 may be configured to emit light 121. The first light source 120 may have low coherence or partial coherence over a defined coherence length. The first light source 120 may be a laser source connected to a fiber optic cable to emit the light 121. In some embodiments, the first light source 120 may be a super-luminescent diode (SLD).

The system 100 may further comprise a first beam splitter 130. The first beam splitter 130 may be configured to direct a first portion 131 of the light 121 from the first light source 120 onto the workpiece 101 and a second portion 132 of the light 121 from the first light source 120 along a reference path 134.

The system 100 may further comprise a refractive optical element 135. The refractive optical element 135 may be disposed in the reference path 134. The refractive optical element 135 may have a varying refractive index profile. For example, the refractive optical element 135 may have a varying thickness that defines the varying refractive index profile. In some embodiments, the refractive optical element 135 may be a spatial light modulator (SLM), which can adjust the shape of the varying refractive index profile. In some embodiments, the varying refractive index profile may be a sinusoidal profile. In some embodiments, the varying refractive index profile may be a non-sinusoidal profile. The refractive optical element 135 may be configured to spatially modulate the second portion 132 of the light 121 from the first light source 120, so as to drive some of the light out of coherence.

The system 100 may further comprise a second beam splitter 140. The second beam splitter 140 may be configured to combine the light 139 refracted by the refractive optical element 135 and the light 111 reflected by the workpiece 101. Based on the spatial modulation of the light 139 refracted by the refractive optical element 135, the contrast interference with the light 111 may vary, depending on the height of the features of the workpiece 101. Accordingly, the phase of the light, modulated by the interference fringes, may be proportional to the height profile of the workpiece 101.

The system 100 may further comprise a first detector 150 and a second detector 155. The first detector 150 and the second detector 155 may be area sensors (e.g., charge-coupled device (CCD), complementary metal-oxide-semiconductor (CMOS), etc.). The first detector 150 may be configured to receive a first portion 141 of the combined light from the second beam splitter 140, and the second detector 155 may be configured to receive a second portion 142 of the combined light from the second beam splitter 140. The first detector 150 and the second detector 155 may be configured to generate a first detection signal 151 and a second detection signal 152 based on the combined light 141 and 142 received from the second beam splitter 140 as the stage 110 scans the workpiece 101 relative to the light 131.

The system 100 may further comprise a processor 160. The processor 160 may include a microprocessor, a microcontroller, or other devices. The processor 160 may be coupled to the components of the system 100 in any suitable manner (e.g., via one or more transmission media, which may include wired and/or wireless transmission media) such that the processor 160 can receive output. The processor 160 may be configured to perform a number of functions using the output. An inspection tool can receive instructions or other information from the processor 160. The processor 160 optionally may be in electronic communication with another inspection tool, a metrology tool, a repair tool, or a review tool (not illustrated) to receive additional information or send instructions.

The processor 160 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 160 may be disposed in or otherwise part of the system 100 or another device. In an example, the processor 160 may be part of a standalone control unit or in a centralized quality control unit. Multiple processors 160 may be used, defining multiple subsystems of the system 100.

The processor 160 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 160 to implement various methods and functions may be stored in readable storage media, such as a memory.

If the system 100 includes more than one subsystem, then the different processors 160 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 160 may be configured to perform a number of functions using the output of the system 100 or other output. For instance, the processor 160 may be configured to send the output to an electronic data storage unit or another storage medium. The processor 160 may be further configured as described herein.

The processor 160 may be configured according to any of the embodiments described herein. The processor 160 also may be configured to perform other functions or additional steps using the output of the system 100 or using images or data from other sources.

The processor 160 may be communicatively coupled to any of the various components or sub-systems of system 100 in any manner known in the art. Moreover, the processor 160 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 160 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 160 (or computer subsystem) or, alternatively, multiple processors 160 (or multiple computer subsystems). Moreover, different sub-systems of the system 100 may include one or more computing or logic systems. Therefore, the above description should not be interpreted as a limitation on the present disclosure but merely an illustration.

The processor 160 may be in electronic communication with the stage 110. For example, the processor 160 may be configured to send instructions to the stage 110 to move the workpiece 101 relative to the detector 150, which scans the first portion 131 of the light 121 from the first light source 120 across the workpiece 101. Accordingly, different portions of the workpiece 101 can be illuminated with the light 121 from the first light source 120. The scan speed of the stage 110 may be related to the period of the refractive optical element 135. For example, the scan speed of the stage 110 may be set such that a minimum of 7 images are captured per period projected by the refractive optical element 135, such that each pixel of the images is sampled with the spatial modulation of the varying refractive index profile.

The processor 160 may be in electronic communication with the first light source 120. For example, the processor 160 may be configured to send instructions to the first light source 120 to emit the light 121.

The processor 160 may be in electronic communication with the first detector 150 and the second detector 155. For example, the processor 160 may be configured to the first detection signal 151 from the first detector 150 and the second detection signal 152 from the second detector 155 as the stage 110 scans the workpiece 101 relative to the light 131 projected onto the workpiece 101. The processor 160 may be further configured to generate a plurality of interference images 153 of the workpiece 101 based on the first detection signal 151 and/or the second detection signal 152. With only one light source, the first detection signal 151 and the second detection signal 152 may be identical, so only one of these two signals may be used to generate the plurality of interference images 153. Each interference image 153 may be captured at a different time as the stage 110 scans the workpiece 101, such that each pixel of the images is sampled with the spatial modulation of the varying refractive index profile. In some embodiments, the plurality of interference images 153 may comprise at least 7 images, which may provide different samples of spatial modulation based on the varying refractive index profile of the refractive optical element 135. The processor 160 may be further configured to determine a relative height of each pixel of the workpiece 101 based on an interference contrast between corresponding pixels of the plurality of interference images 153. For example, when the first detector 150 and the second detector 155 acquire the first detection signal 151 and the second detection signal 152 while the stage 110 is scanning, the contrast of the fringes (i.e., the light reflected by the workpiece 101 and the light 139 refracted by the refractive optical element 135 of the combined light 141 and 142) will be higher whenever the optical distances of the reference path match the sample path affected by the height of the workpiece 101. Accordingly, each height will produce better contrast at a certain part of the scan, and worse contrast at other parts of the scan, in accordance with the spatial modulation of the light 139 refracted by the refractive optical element 135. By tracking and calculating the response of the interference contrast per pixel in the plurality of interference images 153 of the workpiece 101, the relative height of each pixel of the workpiece 101 can be measured.

In some embodiments, the system 100 may further comprise an objective lens 115. The objective lens 115 may be disposed in the path of the first portion 131 of the light 121 directed to the workpiece 101.

In some embodiments, the system 100 may further comprise a tube lens 116. The tube lens 116 may be disposed in the path of the light 111 reflected by the workpiece 101 between the first beam splitter 130 and the second beam splitter 140.

In some embodiments, the system 100 may further comprise at least one mirror disposed in the reference path 134. For example, the system 100 may comprise a first mirror 136 configured to receive the second portion 132 of the light 121 from the first beam splitter 130, and the system 100 may further comprise a second mirror 137 configured to receive the light from the first mirror 136. The second mirror 137 may be configured to direct the light from the first mirror 136 to the refractive optical element 135.

In some embodiments, the second mirror 137 may be configured to change the orientation of the light 139 refracted by the refractive optical element 135. For example, as shown in FIG. 1, the second mirror 137 may direct the light in the reference path 134 to the refractive optical element 135 such that the light 139 refracted by the refractive optical element 135 is off-axis relative to the light 111 reflected by the workpiece 101 combined by the second beam splitter 140.

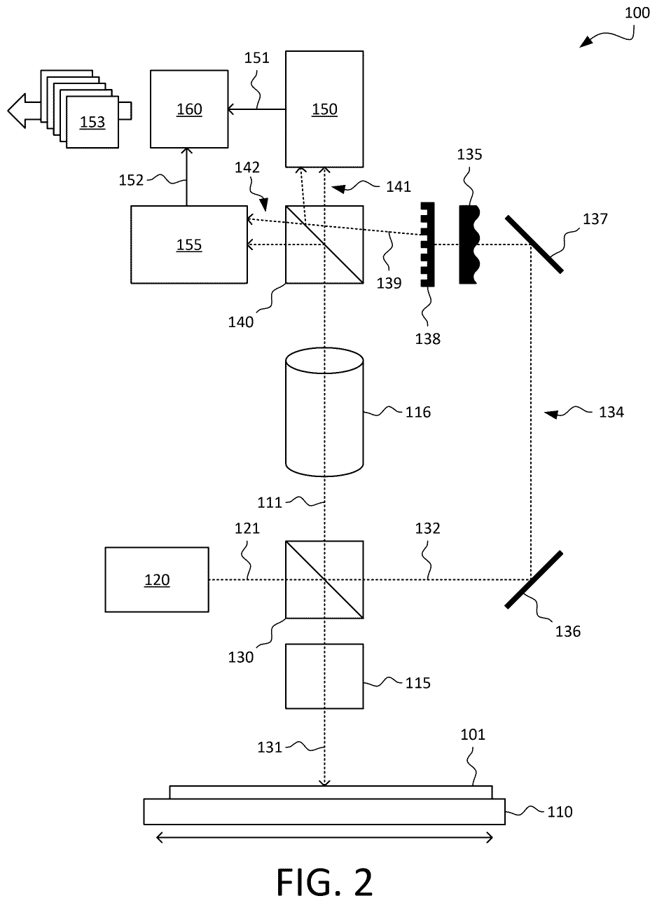

In some embodiments, the system 100 may further comprise a grating 138 disposed in the reference path 134, as shown in FIG. 2. The grating 138 may be configured to adjust the angle of the light 139 refracted by the refractive optical element 135, such that the light 139 is off-axis relative to the light 111 reflected by the workpiece 101 combined by the second beam splitter 140. By providing the light at an off-axis angle, the interference pattern may be more uniform across the field of view, including for low-coherence light sources.

The system 100 may further comprise one or more additional optical elements, such as beam splitters, mirrors, lenses, beam expanders, polarizers, filters (e.g., spectral or chromatic filters), or other elements.

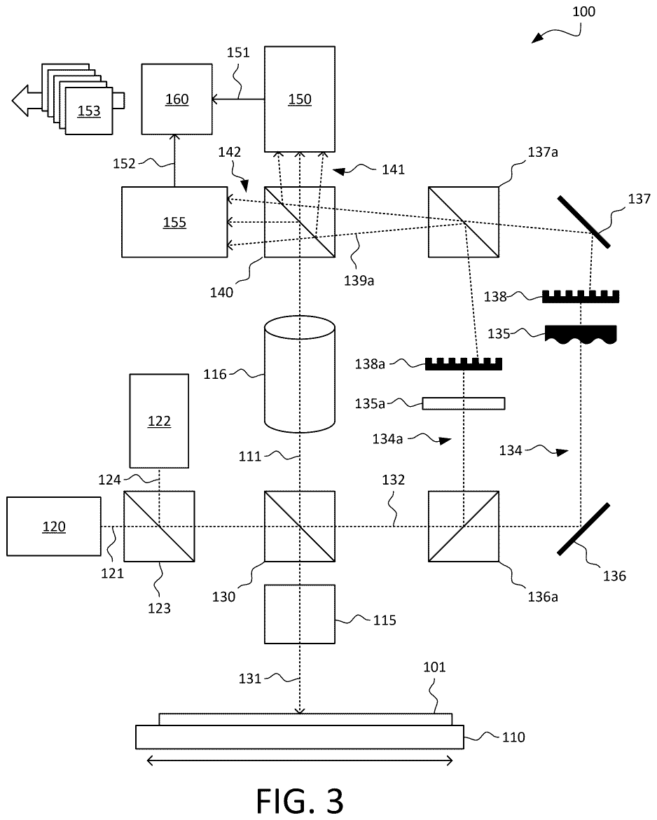

In some embodiments, the system 100 may further comprise a second light source 122, as shown in FIG. 3. The processor 160 may be in electronic communication with the second light source 122 to control the second light source 122 to emit light 124. The light 121 emitted by the first light source 120 may have a lower coherence than the light 124 emitted by the second light source 122. Accordingly, the second light source 122 may provide coherent digital holography data. In some embodiments, the light 124 emitted by the second light source 122 may be of a different wavelength from the light 121 from the first light source 120, which may effectively create a longer measurement range for multi-wavelength unwrapping.

The system 100 may further comprise an illumination beam splitter 123. The illumination beam splitter 123 may be configured to direct the light 121 from the first light source 120 and the light 124 from the second light source 122 to the first beam splitter 130. In some embodiments, the illumination beam splitter 123 may be a polarizing beam splitter. The light 124 from the second light source 122 may travel along the same path as the light 121 from the first light source 120. For example, the first portion 131 of the light directed to the workpiece 101 by the first beam splitter 130 and the second portion 132 of the light directed to the reference path 134 may contain both the light 121 from the first light source 120 and the light 124 from the second light source 122. The reference path 134 may be split into a secondary reference path 134a by a first reference beam splitter 136a. A filter 135a may be disposed in the secondary reference path 134a to filter the light of the waveband of the first light source 120 or the second light source 122. A second grating 138a may be disposed in the secondary reference path 134a to adjust the angle of the light in the secondary reference path 134a to be different from the angle of the grating 138 provided in the reference path 134. The light in the reference path 134 and the secondary reference path 134a may be combined by a second reference beam splitter 137a into multi-wavelength combined light 139a, containing off-axis light from both light sources at different angles relative to the sample beam, one of which is spatially modulated by the refractive optical element 135. Using the first light source 120 and the second light source 122 can allow for different acquisition rates for the coarse measurement of the spatially-modulated contrast data (which may be collected over several frames for 3D analysis) that will only come from one of the wavelengths, and the fine DHM measurement, which can multiplex two wavelengths on the same camera, as long as the reference paths arrive at different solid angles. In some embodiments where the light 121 emitted from the first light source 120 has a different wavelength from the light 124 emitted from the second light source 122, one of the first detector 150 and the second detector 155 may be configured to detect light of the waveband of the first light source 120 or the second light source 122. Alternatively, the first detector 150 and the second detector 155 can multiplex multiple wavelengths on the same sensor. The first detector 150 and the second detector 155 may be configured to generate the first detection signal 151 and the second detection signal 152 based on the combined light 141 and 142 received from the second beam splitter 140 as the stage 110 scans the workpiece 101 relative to the light 131.

The processor 160 may be further configured to receive the first detection signal 151 from the first detector 150 and the second detection signal 152 from the second detector 155. The processor 160 may be configured to generate a plurality of interference images 153 based on the first detection signal 151 and the second detection signal 152. With two light sources, the first detection signal 151 and the second detection signal 152 may provide additional interference information, so both signals may be used to generate the plurality of interference images 153. Each interference image 153 may be captured at a different time as the stage 110 scans the workpiece 101, such that each pixel of the images are sampled with the spatial modulation of the varying refractive index profile. In some embodiments, the plurality of interference images 153 may comprise at least 7 images, which may provide different samples of spatial modulation based on the varying refractive index profile of the refractive optical element 135. The plurality of interference images 153 may indicate the wrapped phase of the system 100. The processor 160 may be further configured to determine the relative height of each pixel of the workpiece 101 based on the interference contrast between corresponding pixels of the plurality of interference images 153. In other words, the coherence-gated data of light from both the first light source 120 and the second light source 122 can be used to unwrap the plurality of interference images 153 to determine the relative height of each pixel of the workpiece 101.

In some embodiments, the processor 160 may be further configured to generate a height map of the workpiece 101 comprising the relative height of each pixel of the workpiece 101 in the plurality of interference images 153. Accordingly, three-dimensional features of the workpiece 101 can be identified for inspection.

In some embodiments, the system 100 may use a single wavelength for phase imaging and a short-period element for coherence-gated imaging with a second wavelength.

In some embodiments, both phase and coherence-gating measurements can use the same wavelength, with different off-axis angles between the light 139 refracted by the refractive optical element 135 and the light 111 reflected by the workpiece 101.

In some embodiments, the system 100 can use two wavelengths for phase imaging, and a third wavelength for coherence-gating. For example, the system 100 may include more than two light sources configured to produce light of three or more wavelengths.

In some embodiments, the system 100 can use two wavelengths for phase imaging, and one of the two wavelengths for coherence-gating.

In some embodiments, the separation of phase and coherence-gating measurements may be produced using polarization, rather than wavelength.

In some embodiments, the refractive optical element 135 may have a varying topography to cause optical path differences of the light in the reference path 134, rather than a varying refractive index.

In some embodiments, the system 100 may be configured to vary the off-axis angle between the light 139 refracted by the refractive optical element 135 and the light 111 reflected by the workpiece 101 for different sensitivities and measurement ranges of interference contrast.

With the system 100, the first light source 120 may provide an inherent supplementary signal for ambiguity unwrapping, which can produce lower resolution 3D data for a much larger effective measurement range, based on the spatial modulation of the refractive optical element 135. In combination with the data collected using light from the second light source 122, the lower resolution data can be used for unwrapping to produce high-resolution and large range 3D data with high throughput. This may provide triangulation-like data, without illuminating the workpiece 101 at an angle, which can avoid occlusions when imaging high aspect ratio features on the workpiece 101.

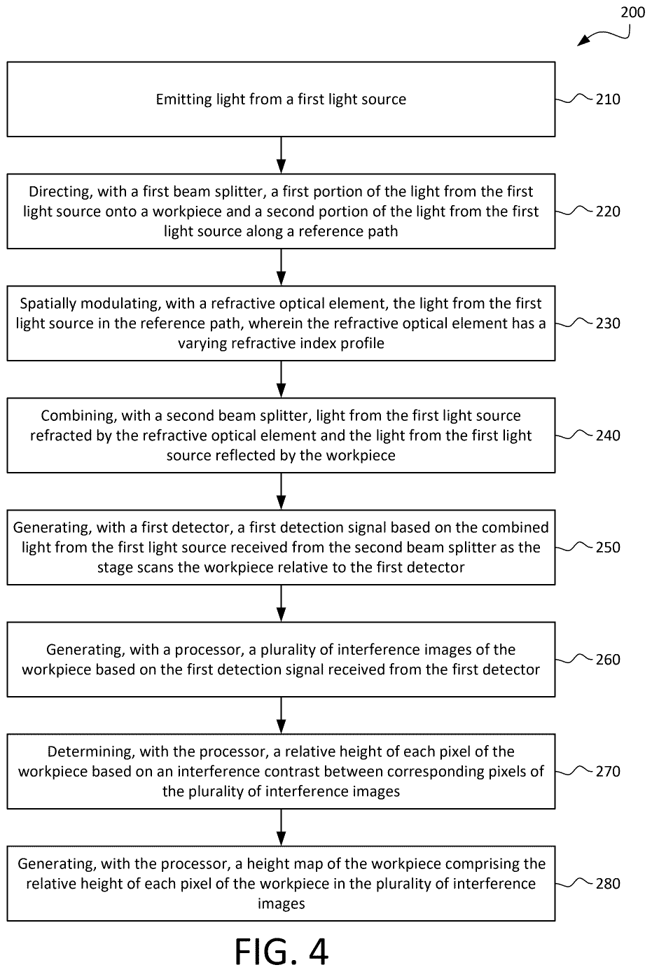

Another embodiment of the present disclosure provides a method 200. As shown in FIG. 4, the method 200 may comprise the following steps.

At step 210, light is emitted from a first light source.

At step 220, a first beam splitter directs a first portion of the light from the first light source onto a workpiece and a second portion of the light from the first light source along a reference path.

At step 230, a refractive optical element spatially modulates the light from the first light source in the reference path.

At step 240, a second beam splitter combines the light from the first light source refracted by the refractive optical element and the light from the first light source reflected by the workpiece.

At step 250, a first detector generates a first detection signal based on the combined light from the first light source received from the second beam splitter as the stage scans the workpiece relative to the first detector.

At step 260, a processor generates a plurality of interference images of the workpiece based on the first detection signal received from the first detector.

At step 270, the processor determines a relative height of each pixel of the workpiece based on an interference contrast between corresponding pixels of the plurality of interference images.

At step 280, the processor generates a height map of the workpiece comprising the relative height of each pixel of the workpiece in the plurality of interference images.

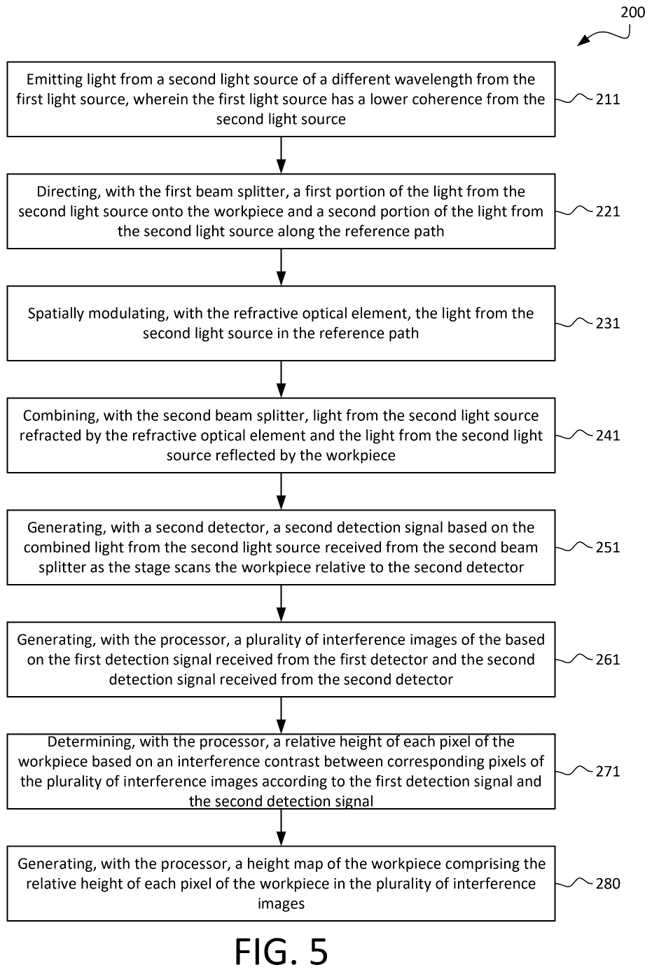

In some embodiments, the method 200 may further comprise the following steps shown in FIG. 5, which may be performed before simultaneously to or in parallel with steps 210 to 270.

At step 211, light emitted from a second light source. The light emitted from the second light source may have a different wavelength from the first light source. The first light source may have a lower coherence from the second light source.

At step 221, the first beam splitter directs a first portion of the light from the second light source onto the workpiece and a second portion of the light from the second light source along the reference path.

At step 231, the refractive optical element spatially modulates the light from the second light source in the reference path.

At step 241, the second beam splitter combines the light from the second light source refracted by the refractive optical element and the light from the second light source reflected by the workpiece.

At step 251, a second detector generates a second detection signal based on the combined light from the second light source received from the second beam splitter as the stage the workpiece scans relative to the second detector.

At step 261, the processor generates a plurality of interference images based on the first detection signal received from the first detector and the second detection signal received from the second detector. With two light sources, the first detection signal and the second detection signal may provide additional interference information, so both signals may be used to generate the plurality of interference images. Each interference image may be captured at a different time as the stage scans the workpiece, such that each pixel of the images are sampled with the spatial modulation of the varying refractive index profile. In some embodiments, the plurality of interference images may comprise at least 7 images, which may provide different samples of spatial modulation based on the varying refractive index profile of the refractive optical element.

At step 271, the processor determines the relative height of each pixel of the workpiece based on the interference contrast between corresponding pixels of the plurality of interference images according to the first detection signal and the second detection signal. The coherence-gated data of light from both the first light source and the second light source can be used to unwrap the plurality of interference images to determine the relative height of each pixel of the workpiece.

With the method 200, the light from the first light source may provide an inherent supplementary signal for ambiguity unwrapping, which can produce lower resolution 3D data for a much larger effective measurement range, based on the spatial modulation of the refractive optical element. In combination with the data collected using light from the second light source, the lower resolution data can be used for unwrapping to produce high-resolution and large range 3D data with high throughput. This may provide triangulation-like data, without illuminating the workpiece at an angle, which can avoid occlusions when imaging high aspect ratio features on the workpiece.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a stage configured to hold a workpiece;
a first light source configured to emit light;
a first beam splitter configured to direct a first portion of the light onto the workpiece and a second portion of the light along a reference path;
a refractive optical element disposed in the reference path and configured to spatially modulate the light in the reference path, wherein the refractive optical element has a varying refractive index profile;
a second beam splitter configured to combine the light from the refractive optical element and the light reflected by the workpiece;
a first detector configured to generate a first detection signal based on the combined light received from the second beam splitter as the stage scans relative to the first detector; and
a processor in electronic communication with the first detector, wherein the processor is configured to:
receive the first detection signal from the first detector;
generate a plurality of interference images of the workpiece based on the first detection signal; and
determine a relative height of each pixel of the workpiece based on an interference contrast between corresponding pixels of the plurality of interference images.

2. The system of claim 1, further comprising:
a second light source configured to emit light, wherein the light emitted by the first light source has a lower coherence than the light emitted by the second light source; and
a second detector configured to generate a second detection signal based on the combined light received from the second beam splitter as the stage scans relative the second detector;
wherein the processor is further configured to:
receive the second detection signal from the second detector; and
generate the plurality of interference images based on the first detection signal and the second detection signal.

3. The system of claim 2, wherein the processor is configured to determine the relative height of each pixel of the workpiece based on the interference contrast between corresponding pixels of the plurality of interference images according to the first detection signal and the second detection signal.

4. The system of claim 2, further comprising:
an illumination beam splitter configured to direct the light from the first light source and the second light source to the first beam splitter.

5. The system of claim 4, wherein the illumination beam splitter is a polarizing beam splitter.

6. The system of claim 2, wherein the second detector is configured to detect the light from the second light source and the first detector is configured to detect light from the first light source.

7. The system of claim 2, further comprising:
a first reference beam splitter configured to split the light in the reference path to a secondary reference path; and
a second reference beam splitter configured to combine the light from the reference path and the secondary reference path to be directed to the second beam splitter;
wherein the light from the reference path and the secondary reference path are provided at different angles from the light reflected by the workpiece in the light combined by the second beam splitter.

8. The system of claim 2, wherein the light emitted by the second light source has a different wavelength from the light emitted by first light source.

9. The system of claim 1, further comprising:
a grating disposed in the reference path between the refractive optical element and the second beam splitter, wherein the grating is configured to adjust an angle of the light from the refractive optical element to be off-axis from the light reflected by the workpiece in the light combined by the second beam splitter.

10. The system of claim 1, further comprising:
a mirror disposed in the reference path between the refractive optical element and the second beam splitter, wherein the mirror is configured to adjust an angle of the light received by the refractive optical element, such that the light from the refractive optical element is off-axis from the light reflected by the workpiece in the light combined by the second beam splitter.

11. The system of claim 1, wherein the processor is further configured to generate a height map of the workpiece comprising the relative height of each pixel of the workpiece in the plurality of interference images.

12. The system of claim 1, wherein the varying refractive index profile is a sinusoidal profile.

13. The system of claim 1, wherein the refractive optical element has a varying thickness that defines the varying refractive index profile.

14. The system of claim 1, wherein the refractive optical element is a spatial light modulator.

15. The system of claim 1, wherein the light from the refractive optical element is off-axis relative to the light reflected by the workpiece in the combined light received by the first detector.

16. The system of claim 1, wherein the plurality of interference images comprises at least seven images captured with different spatial modulation of the light refracted by the refractive optical element.

17. A method comprising:
emitting light from a first light source;
directing, with a first beam splitter, a first portion of the light from the first light source onto a workpiece and a second portion of the light from the first light source along a reference path;
spatially modulating, with a refractive optical element, the light from the first light source in the reference path, wherein the refractive optical element has a varying refractive index profile;
combining, with a second beam splitter, the light from first light source refracted by the refractive optical element and the light from the first light source reflected by the workpiece;
generating, with a first detector, a first detection signal based on the combined light from the first light source received from the second beam splitter as the stage scans relative to the first detector;
generating, with a processor, a plurality of interference images of the workpiece based on the first detection signal received from the first detector; and
determining, with the processor, a relative height of each pixel of the workpiece based on an interference contrast between corresponding pixels of the plurality of interference images.

18. The method of claim 17, further comprising:
emitting light from a second light source, wherein the light emitted by the first light source has a lower coherence than the light emitted by the second light source;
directing, with the first beam splitter, a first portion of the light from the second light source onto the workpiece and a second portion of the light from the second light source along the reference path;
spatially modulating, with the refractive optical element, the light from the second light source in the reference path;
combining, with the second beam splitter, the light from the second light source refracted by the refractive optical element and the light from the second light source reflected by the workpiece;
generating, with a second detector, a second detection signal based on the combined light from the second light source received from the second beam splitter as the stage scans relative to the second detector; and
generating, with the processor, and a plurality of interference images based on the first detection signal and the second detection signal.

19. The method of claim 18, wherein determining, with the processor, the relative height of each pixel of the workpiece based on the interference contrast between corresponding pixels of the plurality of interference images comprises:
determining, with the processor, the relative height of each pixel of the workpiece based on the interference contrast between corresponding pixels of the plurality of interference images according to the first detection signal and the second detection signal.

20. The method of claim 17, further comprising:
generating, with the processor, a height map of the workpiece comprising the relative height of each pixel of the workpiece in the plurality of interference images.
